(19) United States
(12) Patent Application Publication
(10) Pub. No.: US 2015/0003422 A1
(43) Pub. Date: Jan. 1, 2015

(54) PROBING DATA

(71) Applicants: Zhong-Yi Jin, Albany, CA (US); Klaus Franz Doppler, Albany, CA (US)

(72) Inventors: Zhong-Yi Jin, Albany, CA (US); Klaus Franz Doppler, Albany, CA (US)

(73) Assignee: Nokia Corporation, Espoo (FI)

(21) Appl. No.: 14/344,668

(22) PCT Filed: Sep. 16, 2011
(86) PCT No.: PCT/US2011/051948

§ 371 Date: Mar. 13, 2014

(51) Int. Cl. H04L 5/02; H04L 27/26; H04W 72/04

(52) U.S. Cl. CPC H04L 5/026; H04W 72/042; H04L 27/2601
USPC 370/335

(57) ABSTRACT

According to an example embodiment, a method may include sending, by an apparatus, a probe requesting for nodes with queued data to acknowledge the probe, receiving, by the apparatus, multiple acknowledgments from the nodes, the multiple acknowledgments overlapping at least partially in time and frequency, determining, by the apparatus, which nodes acknowledged the probe by decoding the multiple acknowledgments according to a code division multiple access scheme, sending, by the apparatus, an allocation to the nodes that acknowledged the probe, the allocation allocating spectral resources for the nodes to send the queued data, and receiving, by the apparatus, the queued data from the nodes that acknowledged the probe.

### TECHNICAL FIELD

This disclosure relates to wireless networks.

### BACKGROUND

In some networks, nodes may have low duty cycles, keeping their radio interfaces off during most times, to save power. The nodes may, for example, be battery-powered. It may be difficult to coordinate communication between the nodes and an access point while maintaining the nodes' low duty cycle time to save power.

### SUMMARY

According to one general aspect, a method may include sending, by an apparatus, a probe requesting for nodes with queued data to acknowledge the probe, receiving, by the apparatus, multiple acknowledgments from the nodes, the multiple acknowledgments overlapping at least partially in time and frequency, determining, by the apparatus, which nodes acknowledged the probe by decoding the multiple acknowledgments according to a code division multiple access (CDMA) scheme, sending, by the apparatus, an allocation to the nodes that acknowledged the probe, the allocation allocating spectral resources for the nodes to send the queued data, and receiving, by the apparatus, the queued data from the nodes that acknowledged the probe.

According to another general aspect, a method may include receiving, by a first node from a second node, a probe inquiring whether the first node has data to send to the second node, in response to receiving the multicast probe, sending, by the first node, an acknowledgment of the probe to the second node according to code division multiple access (CDMA), and receiving, by the first node from the second node, an allocation of spectral resources.

According to another general aspect, an apparatus may include at least one processor and at least one memory comprising computer program code executable by the at least one processor. The code may be configured to cause the apparatus to at least send a probe requesting for nodes with queued data to acknowledge the probe, receive multiple acknowledgments from the nodes, the multiple acknowledgments overlapping at least partially in time and frequency, determine which nodes acknowledged the probe by decoding the multiple acknowledgments according to a code division multiple access (CDMA) scheme, send an allocation to the nodes that acknowledged the probe, the allocation allocating spectral resources for the nodes to send the queued data, and receive the queued data from the nodes that acknowledged the probe.

According to another general aspect, an apparatus may include at least one processor and at least one memory comprising computer program code executable by the at least one processor. The code may be configured to cause the apparatus to at least receive a probe inquiring whether the apparatus has data to send to the node, in response to receiving the probe, send an acknowledgment of the probe to the node according to code division multiple access (CDMA), and receive an allocation of spectral resources.

According to another general aspect, a non-transitory computer-readable storage medium may comprise computer-executable code stored thereon that, when executed by at least one processor, is configured to cause an apparatus to at least send a probe requesting for nodes with queued data to acknowledge the probe, receive multiple acknowledgments from the nodes, the multiple acknowledgments overlapping at least partially in time and frequency, determine which sensor nodes acknowledged the probe by decoding the multiple acknowledgments according to a code division multiple access (CDMA) scheme, send an allocation to the nodes that acknowledged the probe, the allocation allocating spectral resources for the nodes to send the queued data, and receive the queued data from the nodes that acknowledged the probe.

According to another general aspect, a non-transitory computer-readable storage medium may comprise computer-executable code stored thereon that, when executed by at least one processor, is configured to cause an apparatus to at least receive, by the apparatus, a probe inquiring whether the apparatus has data to send to the node, in response to receiving the probe, send an acknowledgment of the probe to the node according to code division multiple access (CDMA), and receive an allocation of spectral resources.

The details of one or more implementations are set forth in the accompanying drawings and the description below. Other features will be apparent from the description and drawings, and from the claims.

### BRIEF DESCRIPTION OF THE DRAWINGS

FIG. 1 is a diagram of a wireless network according to an example embodiment.

FIG. 2A is a vertical time-sequence diagram showing messages exchanged between an access point and nodes within a group according to an example embodiment.

FIG. 2B is a vertical time-sequence diagram showing messages exchanged between the access point and two different groups of nodes according to an example embodiment.

FIG. 3A is a diagram showing a probe message according to an example embodiment.

FIG. 3B is a diagram showing an acknowledgment from a node according to an example embodiment.

FIG. 3C is a diagram showing a pull message according to an example embodiment.

FIG. 3D is a diagram showing a data message according to an example embodiment.

FIG. 3E is a diagram showing an acknowledgment message sent by the access point according to an example embodiment.

FIG. 4 is a time-frequency diagram showing overlapping acknowledgments sent by nodes according to an example embodiment.

FIG. 5A is a time-frequency diagram showing data messages sent by nodes during allocated times and frequencies.

FIG. 5B is a time-frequency diagram showing data messages sent by nodes during allocated times and frequencies with two messages sent by different nodes at a same time with same frequencies.

FIG. 6 is a flowchart showing node operations according to an example embodiment.

FIG. 7 is a flowchart showing access point operations according to an example embodiment.

FIG. 8 is a block diagram showing a sensor node according to an example embodiment.

FIG. 9 is a block diagram showing an access point according to an example embodiment.

FIG. 10 is a flowchart showing a method according to an example embodiment.

FIG. 11 is a flowchart showing a method according to another example embodiment.

### DETAILED DESCRIPTION

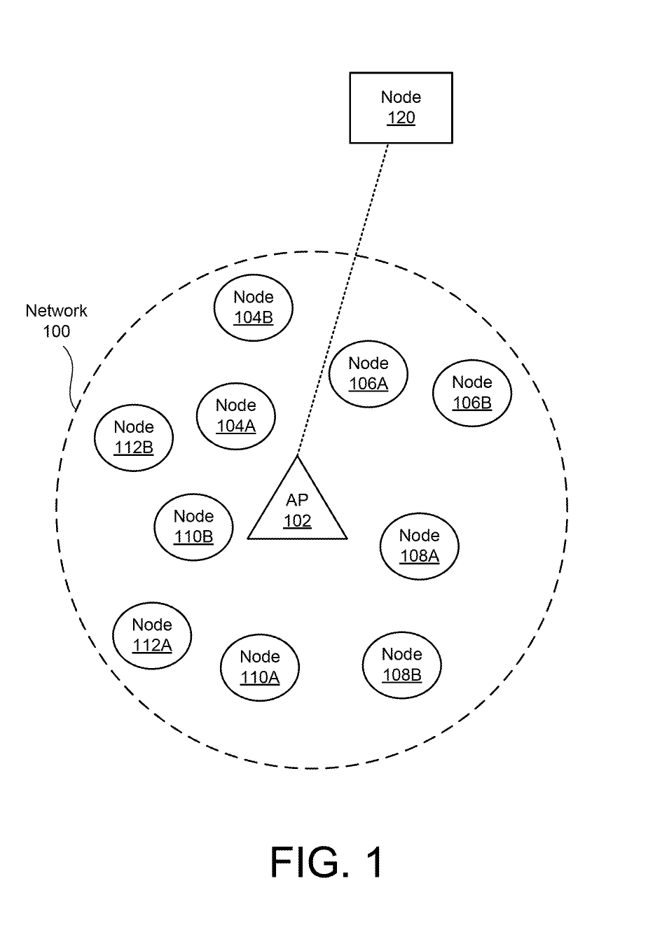

FIG. 1 is a diagram of a wireless network 100 according to an example embodiment. The wireless network 100 may include a network with multiple devices capable of wirelessly communicating with the other devices. The wireless network 100 may include, for example, an IEEE 802.11 WLAN network, an 802.16 WiMAX network, an 802.15 Bluetooth network, or a cellular telephone network, as non-limiting examples. While the terminology of 802.11 WLAN networks is used herein, this disclosure is also applicable to other wireless networks.

The nodes within wireless network 100 may include transducers used to detect events and collect data about the events which occur outside the wireless devices. The events outside the nodes may be inputs into the nodes, which the transducers of the nodes convert into data. The network 100 may, for example, monitor events, such as gas, water, or power usage, environmental or agricultural conditions such as temperature, humidity, wind speed and direction, water levels, pollution information, soil conditions, plant or crop conditions, animal or livestock conditions and locations, or disaster detection information, such as forest fires, floods, or earthquake conditions, such as vibration levels. The events may be monitored by multiple wireless sensor nodes, which may record and send the data to a centralized node, which may include an 802.11 access point. While the term, “sensor node” is used in, the present disclosure may be applied to any nodes capable of wirelessly communicating with other nodes. This disclosure may apply to wireless networks with nodes that transfer data with a low duty cycle. The sensor nodes in the network 100 may monitor the events and send data recording the events to the access point. The centralized node may collect and send the data out of the network 100, such as via a wired backhaul network or to one or more other wireless nodes outside the network 100.

Power consumption may be an important issue for some of the nodes in the network 100; the nodes may, for example, rely on limited battery power. Nodes may be far away from each other, such as up to one kilometer away, requiring a high transmission power to send messages. The limited battery power may make it desirable for at least some of the nodes to utilize limited duty cycles for their wireless or radio interfaces, putting the wireless interfaces to sleep most of the time. Sensor nodes may have duty cycles of less than one percent (<1%), five percent (<5%), two percent (<2%), or one-tenth of a percent (<0.1%), as non-limiting examples.

The network 100 may also include a high number of sensor nodes, such as up to 6,000 sensor nodes. The high number of nodes may make unscheduled communication difficult, because if too many nodes send messages at a same time, the messages may interfere with each other.

In an example embodiment, the sensor nodes may keep their wireless interfaces in a sleeping, inactive, or low-power state until they have data to send. While the sleeping, inactive, or low-power state may refer to the state of the wireless or radio interfaces, the sleeping, inactive, or low-power state may also refer to a state of other circuitries or modules within the nodes, such as baseband processors which may process, modulate, and/or demodulate data for transmitting and/or receiving by a wireless or radio interface. The nodes, which may include sensor nodes, may, for example, monitor events while maintaining their wireless or radio interfaces in the inactive state. In one example embodiment, the sensor nodes may not record an event unless a value, such as temperature or activity, exceeds a threshold, at which point the sensor node will record the event and have data to send. In another example, the sensor nodes may record multiple events, even if the events are not out of the ordinary, and be ready to send data when the events reach a predetermined level on their queue. In either example, when the sensor node has data to send, the sensor node may transition its wireless interface (or other module) to an active state. In the active state, the sensor nodes may listen for probe messages from the access point, which may initiate the sending of the recorded data from the sensor nodes to the access point.

The access point may also have a limited duty cycle, or may continually maintain its wireless interface in an active state. The access point may send probe messages to the sensor nodes periodically, or non-periodically, such as based on prompts from outside the wireless network 100. The probe message may identify a group of sensor nodes, such as a multicast group, or may be broadcast. The sending of the probe message that identifies the group of sensor nodes may allow the access point to probe the sensor nodes in the group in parallel to determine which sensor nodes have data to transmit, how much data each sensor node needs to transmit, and the quality of service required for each sensor node's data transfer. The access point need not send the probe using CDMA, and may send the probe using a communication protocol that does not apply CDMA. The probe may initiate the probing process to pull data from the sensor nodes, initiate a code distribution mechanism in which the probed sensor nodes use low cross-correlation CDMA coding sequences to acknowledge the probe in parallel, and determine timing for the sensor nodes' sending of data to satisfy uplink orthogonal frequency division multiple access (OFDMA) requirements. The access point may trade performance for receiver correlation by controlling a size of the group to which the probe message is sent. The sensor nodes with data to send, and which are part of the multicast group if the probe message identified a multicast group, may receive and process the probe message. The sensor nodes may respond to the probe message with acknowledgment messages.

The sensor nodes may send the acknowledgment messages to the access node using a code division multiple access (CDMA) scheme. As used herein, CDMA may refer to multiple nodes sending using different code sequences, and does not necessarily require using spreading codes. Sending the acknowledgment messages using CDMA may allow multiple, previously unknown sensor nodes to send their acknowledgment messages to the access point using the same time and frequency space, without preventing the access point from interpreting, decoding, and/or processing their respective acknowledgment messages. The access point may, for example, decode the received signal, which may be a sum of all of the acknowledgment messages sent by the sensor nodes, using CDMA code sequences associated with each of the sensor nodes to which the access point sent the probe message. The access point may determine that, for each code sequence that successfully decoded the received signal, the sensor node associated with the code sequence sent the acknowledgment message.

The number of code sequences that the access point uses to decode the received signal may be much higher than the number of sensor nodes that sent acknowledgment messages. However, the use of CDMA for the unknown sensor nodes with data to send their acknowledgment messages allows all of the probed sensor nodes to have the opportunity to send acknowledgment messages. The nodes may each have a fixed single code sequence to send as an acknowledgment if the respective sensor node has data to send. The noise floor created by the sensor nodes sending acknowledgments should be low enough for the access point to successfully decode the signal and process the acknowledgment messages from each of the sensor nodes; this low noise floor may be based on only a fraction of the probed sensor nodes sending acknowledgments, or the group of probed sensor nodes may be small enough that even if all of the probed sensor nodes send acknowledgments, the noise floor will still be low enough for the access point to successfully decode the signal. The access point may thereby rely on trunking to probe a larger number of sensor nodes than would be able to send acknowledgment messages at once, in the example in which the number of sensor nodes sending acknowledgments should be much smaller than the number of sensor nodes to which the probe message was sent, and low enough for their collective interference to be low enough for the access point to be able to decode each of the acknowledgments. However, in this trunking scheme using CDMA, the access point need not know, at the time of sending the probe message and receiving the acknowledgment messages, which sensor nodes have data to send and will send acknowledgment messages. Or, the access point may create groups which are small enough so that even if all of the probed sensor nodes send their acknowledgments at once, the access point will still be able to decode each of the acknowledgments.

After decoding the acknowledgment messages, the access point may know which sensor nodes sent the acknowledgment messages and have data to send. The access point may send pull messages, or spectral allocation messages, to the sensor nodes that sent the acknowledgment messages indicating that they have data to send. The pull or spectral allocation messages may allocate spectral resources, such as frequency subcarriers and time slots, to each of the sensor nodes which have data to send. The sensor nodes may send their data using the allocated spectral resources. The access point may acknowledge receiving the data, and the sensor nodes may, upon receiving the respective acknowledgments from the access point, delete or dequeue the queued data.

In the example shown in FIG. 1, the wireless network 100 may include an access point 102. The access point 102 may include, for example, an 802.11 access point, an 802.16 base station, a node B, or other fixed or non-fixed wireless node. The access point 102 may communicate with other nodes in the wireless network 100. The access point 102 may communicate with the other nodes in the wireless network 100 via a wireless, air, or radio interface. The access point 102 may have engaged in network entry procedures with the other nodes, which may include exchanging address information and other communication parameters. The access point 102 may, for example, have assigned group addresses, node addresses, CDMA codes, and other parameters to the sensor nodes, as non-limiting examples.

The wireless network 100 may also include sensor nodes. In the example shown in FIG. 1, the sensor nodes have been assigned to two groups, group A and group B. The access point 102 may have assigned the nodes into the groups based on likelihoods that the nodes in each respective group will not unduly interfere with each other when sending acknowledgments to the access point 102 via a code division multiple access (CDMA) scheme. For example, the access point 102 may determine the maximum number of sensor nodes to assign into a group given a quality of a channel via which the access point 102 communicates with the sensor nodes. The higher the quality of the channel via which the access point 102 will communicate with the nodes, the more sensor nodes may be assigned into a group, whereas the lower the quality of the channel via which the access point 102 will communicate with the nodes, the fewer nodes may be assigned into the group. The maximum nodes in the group may be determined based on a minimum likelihood that the access point 102 will be able to successfully interpret acknowledgment messages sent by the sensor nodes. While only two groups are shown in the wireless network 100 shown in FIG. 1, the access point 102 may assign more than two groups, according to example embodiments.

In the example shown in FIG. 1, group A includes sensor nodes 104A, 106A, 108A, on 110A, and 112A, and group B includes sensor nodes 104B, 106B, 108B, 110B, and 112B. While the groups A and B shown in FIG. 1 each include only five sensor nodes, the groups may include many more sensor nodes, such as up to 6,000 sensor nodes. The access point 102 may assign sensor nodes 104A, 106A, 108A, 110A, 112A, 104B, 106B, 108B, 110B, 112B into groups randomly based on MAC addresses, or based on considerations such as reducing interference or optimizing communication. For example, the access point 102 may assign sensor nodes 104A, 106A, 108A, 110A, 112A, 104B, 106B, 108B, 110B, 112B with disparate locations into a same group to minimize interference with each other and/or to reduce the likelihood that sensor nodes 104A, 106A, 108A, 110A, 112A, 104B, 106B, 108B, 110B, 112B in a same group will detect events at a same time, or the access point 102 may assign sensor nodes 104A, 106A, 108A, 110A, 112A, 104B, 106B, 108B, 110B, 112B with similar locations into a same group to facilitate sectoring.

The sensor nodes 104A, 106A, 108A, 110A, 112A, 104B, 106B, 108B, 110B, 112B may also include 802.11 access points or other devices capable of communicating with the access point 102 via 802.11 communication and networking protocols, or devices capable of communicating with the access point 102 via other wireless protocols. While the access point 102 and sensor nodes 104A, 106A, 108A, 110A, 112A, 104B, 106B, 108B, 110B, 112B are discussed with respect to the access point 102 acting as a centralized node, the disclosure included herein may also apply to mesh networks, in which any node may probe and pull data from other nodes.

In this example shown in FIG. 1, the access point 102 may be in communication with a node 120 which is outside the network 100. The node 120 may be an electronic device capable of receiving and sending data and instructions via a wired and/or wireless interface. The access point 102 may be in communication with the node 120 via a wired or wireless backhaul network, via the Internet, or the node 120 may serve as a relay node intermediate to a location at which the collected data may be analyzed. The access point 102 may collect and send the data to the final destination via the node 120. The node 120 may also instruct the access point 102 to pull the data from the sensor nodes 104A, 106A, 108A, 110A, 112A, 104B, 106B, 108B, 110B, 112B, prompting the access point 102 to send the probe message to the sensor nodes 104A, 106A, 108A, 110A, 112A, 104B, 106B, 108B, 110B, 112B in response to the access point 102 receiving the instruction from the node 120.

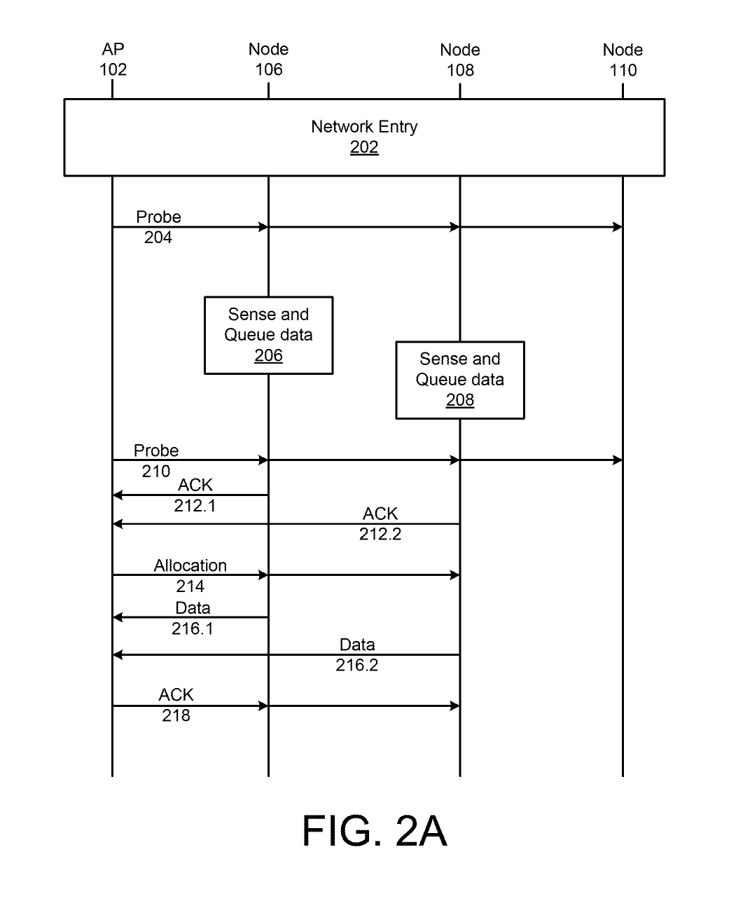

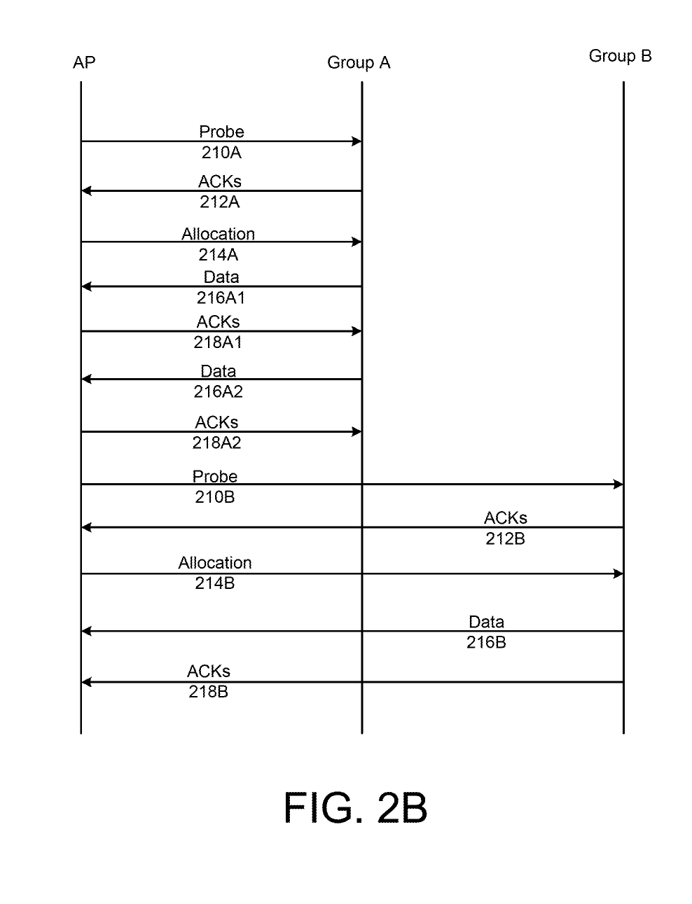

FIG. 2A is a vertical time-sequence diagram showing messages exchanged between the access point 102 and sensor nodes 106, 108, 110 within a group according to an example embodiment. While three sensor nodes 106, 108, 110 are shown in FIG. 2A, many more sensor nodes may be included in the group, according to example embodiments.

The access point 102 and sensor nodes 106, 108, 110 may engage in network entry procedures (202). While FIG. 2A shows the access point 102 and sensor nodes 106, 108, 110 entering the network 100 (shown in FIG. 1) at approximately a same time, different sensor nodes in the network 100 may enter the network 100 at different times. For example, some sensor nodes may have previously entered the network 100, and other sensor nodes may exit the network 100 after or during the other processes shown in and described with respect to FIG. 2A. While not shown in FIG. 2A, sensor nodes may also exit the network 100 before, during, or after any of the processes shown in and described with respect to FIG. 2A.

During the network entry (202), the access point 102 and sensor node(s) 106, 108, 110 may engage in authentication and association procedures, exchanging parameters such as addresses or identifiers and capability information. The nodes 102, 106, 108, 110 may also negotiate and/or determine which node 102, 106, 108, 110 will act as the access point and collect and forward data from the other nodes. The access point 102 may also assign CDMA coding sequences to the sensor nodes 106, 108, 110 during network entry (202), or the access point 102 may wait to assign the CDMA coding sequences, and assign the CDMA coding sequences to the sensor nodes 106, 108, 110 when sending probes to the sensor nodes 106, 108, 110 by including the CDMA coding sequences in the probes, as discussed below.

After (or before) entering the network 100, the sensor nodes 106, 108, 110 may monitor events. The sensor nodes 106, 108, 110 may monitor events such as gas, water, or power usage, environmental or agricultural conditions such as temperature, humidity, wind speed and direction, water levels, pollution information, soil conditions, plant and crop conditions, animal or livestock conditions and locations, or disaster detection information, such as forest fires, floods, or earthquake conditions, such as vibration levels. When the monitoring results in events which merit reporting, the sensor nodes 106, 108, 110 may record and/or queue data recording the events in their respective memories. While monitoring, the sensor nodes 106, 108, 110 may maintain their respective air and/or radio interfaces in inactive, sleep, or low-power states to save power. The sensor nodes 106, 108, 110 may maintain their respective air and/or radio interfaces in inactive, sleep, or low-power states until they have data to send to the access point 102, such as when an event to be reported is monitored and/or queued, or when their queues reach a threshold value.

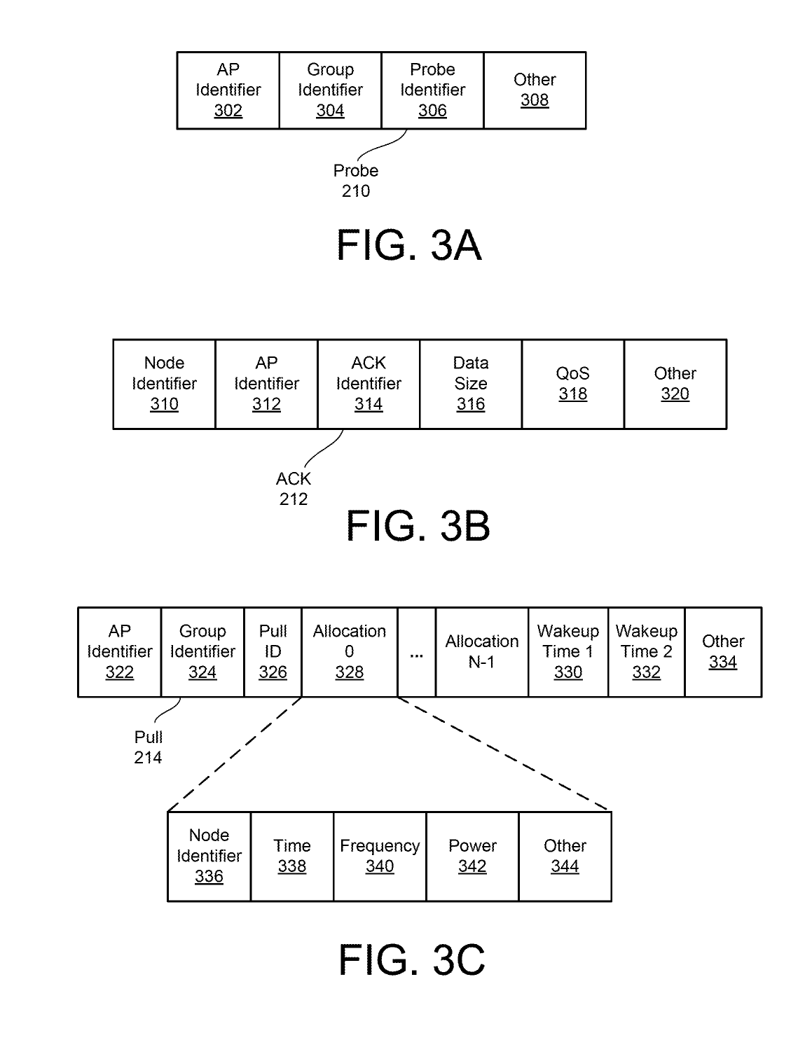

During the time that the sensor nodes are monitoring events, the access point 102 may send a probe message 204 to the sensor nodes 106, 108, 110. The access point 102 may, for example, send the probe message 204 to the sensor nodes 106, 108, 110 as a multicast or groupcast message to the multicast group or group of sensor nodes 106, 108, 110. The group or multicast group of sensor nodes 106, 108, 110 may have been predetermined and assigned by the access point 102. The probe message 204 may include a multicast group identifier of the multicast group or a groupcast identifier of the group to which the probe message is sent. Probe messages will be discussed further below with respect to the probe message 210 shown in FIGS. 2A and 3A.

In the example shown in FIG. 2A, none of the sensor nodes 106, 108, 110 may have queued data to send to the access point 102 when the access point 102 sends the probe message 204, and the sensor nodes 106, 108, 110 may have their respective air and/or radio interfaces in inactive, sleep, or low-power states when the access point 102 sends the probe message 204. Because the sensor nodes 106, 108, 110 have their respective air and/or radio interfaces in inactive, sleep, or low-power states when the access point 102 sends the probe message 204, the sensor nodes 106, 108, 110 may not receive, process, or respond to the probe message 204. Based on not receiving a response to the probe message 204, the access point 102 may wait a predetermined period of time (during which the access point 102 may or may not transition its air or radio interface into an inactive, sleep, or low-power state), may wait until an event, such as an instruction from the node 120 (shown in FIG. 1) prompts another probe message, or may send a probe message to another multicast group or group of sensor nodes.

As discussed above, the sensor nodes 106, 108, 110 may monitor events. In the example shown in FIG. 2A, sensor node 106 may sense and queue data (206), and sensor node 108 may sense and queue data (208). The sensing and queuing data (206, 208) may include sensing an event to be reported, and/or sensing enough events for the queue to reach a reporting threshold. Based on sensing and queuing data (206, 208), the sensor nodes 106, 108 may transition their respective air or radio interfaces from the inactive, sleep, or low-power state, to an active, awake, or full- (or higher-) power state, and may listen for a probe message from the access point 102. Based on the sensing and queuing data (206, 208), the sensor nodes 106, 108 may be ready to receive, process, and respond to a probe message from the access point 102.

In the example shown in FIG. 2A, the sensor node 106 sensed and queued data (206) and transitioned its air or radio interface to the active, awake, or full-power state before the sensor node 108 sensed and queued data (208) and transitioned its air or radio interface to the active, awake, or full-power state, and the sensor node 110 has not sensed an event for reporting or filled its queue to a level which should be forwarded to the access point 102, and the sensor node 110 is maintaining its air or radio interface in the inactive, sleep, or low-power state. However, any number of sensor nodes may sense and queue data and transition their respective air interfaces into active, awake, or full-power states, in any order, either concurrently or non-concurrently, based on the respective events that the sensor nodes are monitoring.

While the sensor nodes 106, 108 which have data to send to the access point 102 are listening for a probe message, the access point 102 may send a probe message 210. FIG. 3A is a diagram showing the probe message 210 according to an example embodiment. The probe message 210 may include an IEEE 802.11 packet or IEEE 802.11 frame, according to example embodiments. While some example fields included in the probe message 210 are shown in FIG. 3A, other fields may be included in the probe message 210.

In the example shown in FIG. 3A, the probe message 210 may include source address and destination address fields. The probe message 210 may include, for example, an access point identifier 302 including an address which identifies the access point 102 that sent the probe message, and a group identifier 304 including an address which identifies the group or multicast group to which the probe message is sent (such as group A, group B, or other group of sensor nodes). The probe message 210 may also include, in addition to or instead of the group identifier, a list of individual addresses, such as forty-eight bit IEEE Medium Access Control (MAC) addresses, and/or MAC addresses assigned for use specifically within the network 100, to identify the nodes being probed. The probe message 210 may also include a type field identifying the type of packet or frame being sent, such as a probe identifier 306 identifying the probe message 210 as a probe message. The probe message 210 may also include other fields 308, such as length fields, data fields, checksum fields, or fields assigning CDMA code sequences to the sensor nodes in the group to which the probe message is addressed (if the CDMA code sequences were not assigned to the sensor nodes during the network entry 202), as non-limiting examples.

The access point 102 may send the probe messages 204, 210 via predetermined frequencies and a predetermined communication protocol (which may have been negotiated during the network entry 202), such as via an orthogonal frequency division multiplexing (OFDM) or orthogonal frequency division multiple access (OFDMA) protocol. The frequency and/or subcarriers may have been previously negotiated or communicated to the sensor nodes 106, 108. The time of transmission of the probe messages 204, 210 may be unknown to the sensor nodes 106, 108, or may have been communicated to sensor nodes by the access point 102 in a pull or allocation message, discussed below.

Returning to FIG. 2A, the sensor nodes 106, 108 with data to send may receive the probe message 210. In response to receiving the probe message 210, the sensor nodes 106, 108 may send acknowledgments 212.1, 212.2 to the access point 102. The sensor nodes 106, 108 may send the acknowledgments 212.1, 212.2 to the access point 102 by CDMA. The sensor nodes 106, 108 may each send their respective acknowledgments to the access point by CDMA using unique or special code sequences assigned to and/or associated with the sensor nodes 106, 108. The code sequences may be unique in that all sensor nodes in a group or multicast group may have different code sequences. While the code sequences may be unique, in an example embodiment, the nodes may have non-unique codes, and coding sequences may be re-used within a group or multicast group, the network 100, or both. The re-use of coding sequences may rely on a low probability of two nodes with the same coding sequence both acknowledging the same probe message 210. In the example in which the coding sequences are non-unique, the access point 102 may subsequently assign spectral or communication resources based on the addresses of the acknowledging nodes or the coding sequences of the acknowledging nodes, and/or the coding sequences of the acknowledging nodes may be functions of their respective addresses. The code sequences may include, for example, Zadoff-Chu code sequences, Walsh codes, or Golden Codes. The code sequences of the sensor nodes within a group or multicast group may be substantially orthogonal to each other, to minimize the likelihood of an acknowledgment sent from one sensor node being mistaken as sent from another sensor node.

The acknowledgments 212.1, 212.2 may include information which may assist the access point 102 in allocating spectral resources to the sensor nodes 106, 108 that acknowledged the probe 210. The acknowledgments 212.1. 212.2 may include, for example, a size of the queued data that the respective node 106, 108 has to transmit to the access point, quality of service (QoS) requirements for the respective sensor node 106, 108 to send the data, and other metadata. The information included in the acknowledgment may be quantized, such as in eight bits.

FIG. 3B is a diagram showing an acknowledgment 212 from a sensor node according to an example embodiment. The acknowledgment 212 may include an IEEE 802.11 frame or IEEE 802.11 packet, and may include fields not shown in the example FIG. 3B.

In the example acknowledgment 212 shown in FIG. 3B, the acknowledgment 212 may include source address and destination address fields, such as a sensor node identifier field 310 identifying the sensing node as the sending node, and an access point identifier field 312 identifying the access point 102 as the receiving node. Or, the source and/or destination address may not be included in the acknowledgment message 212, and the access point 102 may identify the sending sensor node 106, 108 based on which coding sequence successfully decodes the acknowledgment message 212. The acknowledgment 212 may also include a field identifying the type of the packet or frame, such as an acknowledgment identifier field 314 identifying the acknowledgment 212 as an acknowledgment, and perhaps as an acknowledgment from the respective sensor node 106, 108 to the access point 102. The acknowledgment 212 may also include a data size field 316, which may indicate the size or length of the queued data which the sensor node has to send to the access point 102. The acknowledgment 212 may also include a QoS field 218, which may indicate a required quality of service level for the sensor node to send the data to the access point 102. The acknowledgment 212 may also include other fields 320, which may include metadata or other information to assist the access point 102 in allocating spectral resources to the sensor node. The other field(s) 320 may, for example, indicate a request for the access point 102 to send data to the sensor node that sent the acknowledgment 212.

Returning to FIG. 2A, the acknowledgments 212.1, 212.2 may combine to form a single summed signal received by the access point 102. The access point 102 may decode the received summed signal a number of times equal to the number of sensor nodes in the probed group or multicast group, using the CDMA code sequences associated with each of the sensor nodes in the probed group or multicast group. While the sensor nodes 106, 108 may send their respective acknowledgments upon receipt of the probe message 210, or with a same delay after receiving the probe message 210, different distances between the access point 102 and the sensor nodes 106, 108 may cause the access point 102 to receive acknowledgments 212.1, 212.2 from different sensor nodes 106, 108 at different times.

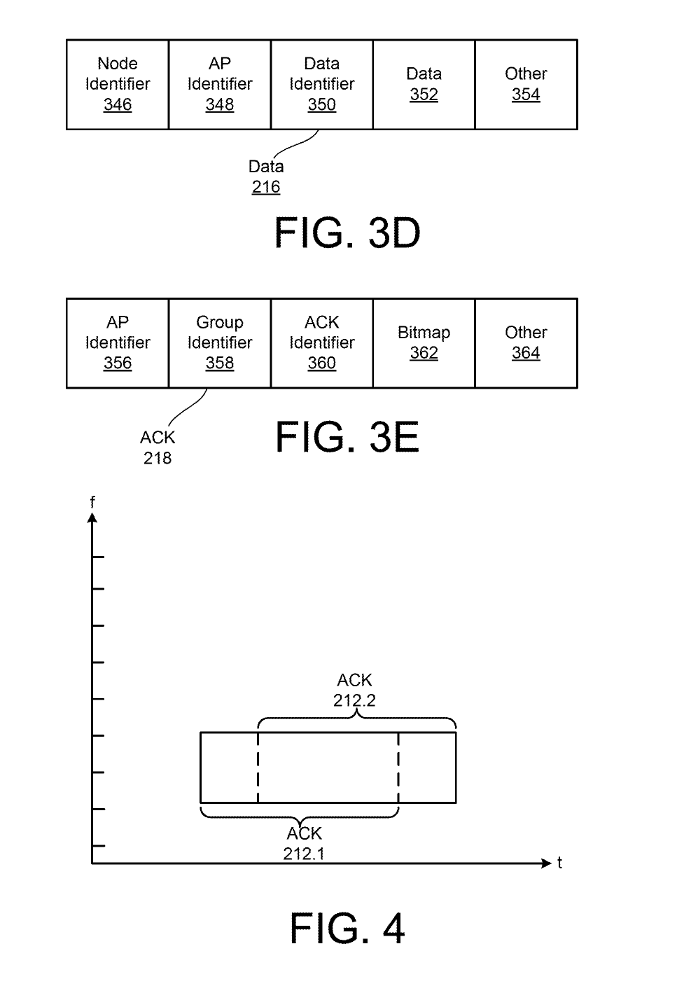

FIG. 4 is a time-frequency diagram showing overlapping acknowledgments sent by sensor nodes according to an example embodiment. While two acknowledgments 212.1, 212.2 are shown in FIG. 4, many more acknowledgments, which may overlap in time and frequency, may be sent by sensor nodes and received by the access point 102. The times of the acknowledgments 212.1, 212.2 shown in the example of FIG. 4 are times of receipt by the access point 102. The access point 102 may determine distances of the sensor nodes based on times of receipt of their associated acknowledgment. In the example shown in FIG. 4, the two acknowledgments 212.1, 212.2 may have been sent from sensor nodes to the access point 102 via the same frequency bandwidth and in response to the same probe message 210, but may be received at different times by the access point 102. The times of receipt may overlap, requiring the access point 102 to perform the CDMA decoding using each coding sequence over multiple time intervals. In the example shown in FIG. 4, acknowledgment 212.1 may be received before acknowledgment 212.2, based on which the access point 102 may determine that the sensor node 106 that sent the acknowledgment 212.1 is closer to the access point 102 than the sensor node 108 that sent the acknowledgment 212.2

Returning to FIG. 2A, based on decoding the received acknowledgments 212.1, 212.2, the access point 102 may determine which sensor nodes 106, 108 have data to send, how much data each sensor node 106, 108 has to send, the quality of service requirements for each node to send data, and the respective distances of each of the sensor nodes 106, 108. Based on this information, the access point 102 may allocate spectral and/or communication resources for each sensor node 106, 108 that acknowledged the probe 210. The access point 102 may, for example, allocate transmission start times and durations, subcarriers, channel bandwidth, frequencies, codes, timing information, and/or transmission power for each of the acknowledging sensor nodes 106, 108 to send data to the access point 102. The access point 102 may allocate spectral or communication resources to the acknowledging sensor nodes 106, 108 during a single data transmission period, or, if the total data from all acknowledging sensor nodes 106, 108 exceeds the capacity of a single data transmission period, the access point 102 may assign a time for these sensor nodes to receive another probe pulling data, allowing these sensor nodes to go to sleep until the subsequent probe packet. Or, these sensor nodes may go to sleep until a specified time at which the access point 102 will send another allocation or pull message

The access point 102 may, for example, allocate more subcarriers and/or higher bandwidth to acknowledging sensor nodes with more data to send, more transmission power to acknowledging sensor nodes which are farther away from the access point 102, and/or earlier start transmission times to sensor nodes which are farther away from the access point 102. The access point 102 may send an allocation or pull message 214 to the acknowledging sensor nodes 106, 108. The allocation or pull message 214 may indicate the spectral or communication resources allocated to each acknowledging sensor node 106, 108.

FIG. 3C is a diagram showing an allocation or pull message 214 according to an example embodiment. The allocation or pull message 214 may be an IEEE 802.11 packet or IEEE 802.11 frame. In this example, the allocation or pull message 214 may include source address and destination address fields, such as an access point identifier 322 identifying the access point 102 as sending the allocation or pull message 214, and a group identifier 324 identifying the group or multicast group to which the allocation or pull message 214 is sent, which may be the same as the group or multicast group to which the probe 210 was sent. The allocation or pull message 214 may also include a type field, such as a pull identifier field 326 identifying the allocation or pull message 214 as an allocation or pull message.

The allocation or pull message 214 may also include an allocation field 328 for each of the N sensor nodes being allocated spectral or communication resources. The allocation field 328 may, for example, include a sensor node identifier subfield 336 identifying the sensor node which is being allocated spectral or communication resources by the respective allocation field 328. The allocation field 328 may also include a time subfield 338, indicating a time at which the sensor node should begin transmitting its data. The time subfield 338 may also indicate a duration for which the sensor node may transmit its data, or the duration may be indicated by a separate subfield. The allocation field 328 may also include a frequency subfield 340, which may indicate subcarriers, channel bandwidth, and/or frequencies via which the sensor node may transmit the data. The subcarriers, channel bandwidth, and/or frequencies may be included in the single separate frequency subfield 340, or may be included in multiple separate subfields. The allocation field 320 may also include a power subfield 342, which may indicate a transmission power or maximum transmission power for the sensor node to transmit its data. The allocation field 328 may also include other subfields 344, which may indicate other allocation information, such as a code that the sensor node should use to transmit the data to the access point 102. Or, if the sensor node identified in the allocation field 328 requested the access point 102 to send downlink data, the other subfield(s) 344 may include downlink data for the requesting sensor node.

The allocation or pull field 214 may also include wakeup time fields 330, 332. A first wakeup time field 330 may be for sensor nodes that have data to transmit but were not part of the group or multicast group identified by the probe 210. The first wakeup time field 330 may indicate a wakeup time for the sensor nodes that have data to transmit but were not part of the group or multicast group identified by the probe 210. The sensor nodes that have data to transmit but were not part of the group or multicast group identified by the probe 210 may, based on receiving the allocation or pull message 214 and the first wakeup time, go to sleep and/or place their air or radio interfaces into inactive, sleep, or low-power modes until the indicated time, at which time the access point 102 may send another probe directed to these nodes.

A second wakeup time field 332 may be for sensor nodes that acknowledged the probe 210, but are not allocated spectral or communication resources to transmit data during the subsequent data transmission period. The second wakeup field 332 may indicate a time for these sensor nodes which acknowledged the probe 210 but are not allocated spectral or communication resources to wake up and receive a subsequent allocation or pull message during which they may be allocated spectral or communication resources. The sensor nodes which acknowledged the probe 210 but are not allocated spectral or communication resources may respond to not being allocated spectral or communication resources by going to sleep, or transitioning their air or radio interfaces into inactive, sleep, or low-power state until the indicated time, at which time they may transition back to active, awake, or full-power state to listen for another allocation or pull message. The allocation or pull message 214 may also include other fields 334. If a sensor node requested a downlink data transmission, the other field(s) 334 may indicate a time for transmitting downlink data.

Returning to FIG. 2A, the sensor nodes 106, 108 may receive the allocation or pull message 214. The sensor nodes that acknowledged the probe 210, but did not receive allocations for spectral or communication resources, may go to sleep until the time indicated by the second wakeup time field 332, at which time they may wakeup. The sensor nodes which have data to transmit, but were not part of the group or multicast group identified by the probe 210, may go to sleep until the time indicated by the first wakeup time field 330, at which time they may wakeup.

The sensor nodes 106, 108 which did receive allocations of spectral or communication resources may send data 216.1, 216.2 during the allocated times, via the allocated frequencies, and/or with the allocated power. The access point 102 may have allocated spectral or communication resources to the sensor nodes to maximize the likelihood of successful receipt of data from the sensor nodes 106, 108, while minimizing the likelihood of interference between the sensor nodes 106, 108, based on the information received by the access point in the acknowledgments 212.1, 212.2. The sensor nodes 106, 108 may send their data 216.1, 216.2 in parallel using OFDM or OFDMA, space-division multiple access (SDMA), or CDMA, according to the allocation indicated by the allocation or pull message 214.

FIG. 3D is a diagram showing a data message 216 according to an example embodiment. The data message 216 may include an IEEE 802.11 frame or IEEE 802.11 packet. The data message 216 may include a source field and data field, such as a sensor node identifier field 346 identifying the sensor node 106, 108 that sent the data message 216, and an access point identifier field 348 identifying the access point 102 as the recipient of the data message 216. The data message 216 may also include a type field, identifying the data message 216 as a data message. The data message 216 may also include a data field 252 which includes the data that the sensor node 106, 108 is sending to the access point 102. The data message 216 may also include other fields 354. The sensor nodes 106, 108 may dequeue their queued data from their respective memories upon sending their respective data messages 216.1, 216.2, or may wait until receiving acknowledgments of the data from the access point 102.

As discussed above, the access point 102 may have scheduled times for transmission of data messages 216.1, 216.2 based at least in part on the distances of the sensor nodes 106, 108. For example, the access point 102 may expect that data from a sensor node that is farther from the access point 102 will be received later than data from a sensor node that is closer to the access point 102, even though the two sensor nodes sent their data at the same time. Or, the access point 102 may expect that data from the sensor node that is farther from the access point will be received at a same time as data from the sensor node that is closer to the access point 102, if the farther sensor node sent its data sufficiently earlier than the closer sensor node. Or, the access point 102 may schedule the data transmissions by the nodes 106, 108 sequentially, without gaps between the transmissions, with the farther nodes 106, 108 transmitting immediately after the closer nodes, with the increased time between transmission and reception of the data sent by the farther nodes preventing overlap of the received data.

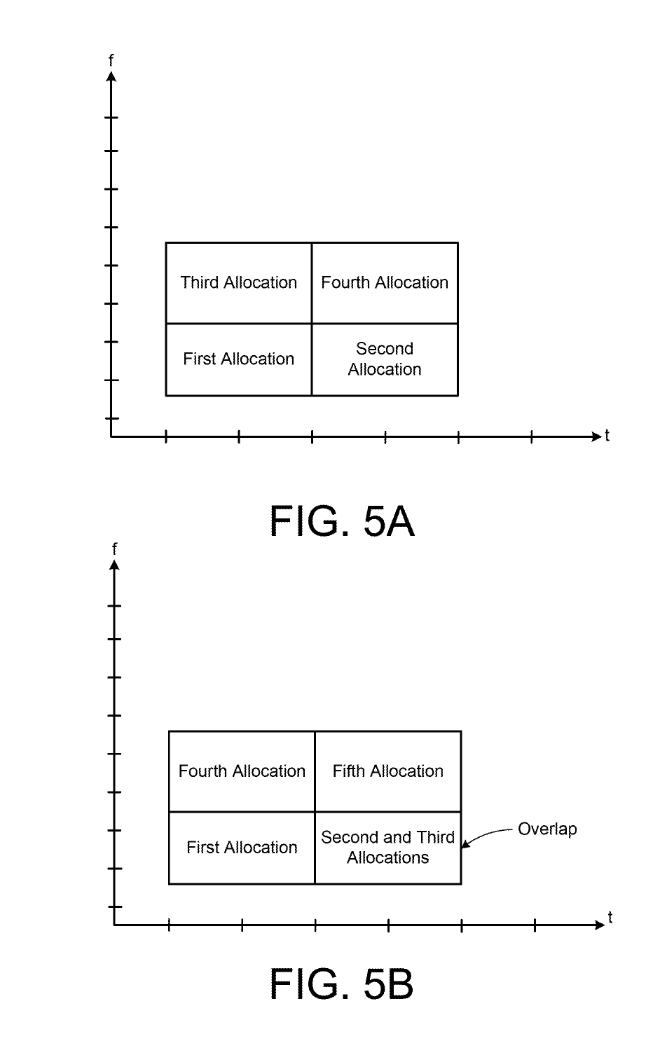

FIG. 5A is a time-frequency diagram showing data messages sent by sensor nodes during allocated times and frequencies. This diagram shows times of transmission and frequency bands for sensor nodes with same distances from the access point 102. In this example, the first allocation and third allocation may have same time slots but successive frequency bands and/or subcarriers, preventing interference between the data sent by the respective sensor nodes. The second allocation and fourth allocation may have later time slots than the first allocation and third allocation, and may have successive frequency bands and/or subcarriers between each other, preventing interference between the data sent by the respective sensor nodes.

FIG. 5B is a time-frequency diagram showing data messages sent by sensor nodes during allocated times and frequencies with two messages sent by different sensor nodes at a same time with same frequencies. This example is similar to the example of FIG. 5A, except that the sensor nodes with the second and third allocations may have different distances from the access point. One of the sensor nodes with the second and third allocations may be sufficiently farther from the access point 102 than the other, allowing the two sensor nodes to send their respective data at a same time, but have their data received at different times. The farther sensor node may, for example, have its data received by the access point 102 just after the data of the closer sensor node is received by the access point 102. While FIG. 5B shows the second and third allocations fully overlapping, allocations of sensor nodes with different distances from the access point 102 may overlap only partially, based on a determination of when the data should be transmitted so that the respective data messages will not overlap upon receipt by the access point 102.

Returning to FIG. 2A, the access point 102 may acknowledge 218 the data messages 216.1, 216.2. The access point 102 may send individual acknowledgments to each sensor node 106, 108 that sent a data message 216.1, 216.2, or may send a single acknowledgment message 218 to all of the sensor nodes 106, 108 that sent a data message 216.1, 216.2. The acknowledgment message 218 may include, for example, a bitmap identifying the sensor nodes 106, 108 that the access point 102 acknowledges receiving data messages 216.1, 216.2 from, or may include the address of all the sensor nodes 106 from which the access point 102 received data message 216.1, 216.2.

FIG. 3E is a diagram showing an acknowledgment message 218 sent by the access point 102 according to an example embodiment. The acknowledgment message 218 may include an IEEE 802.11 frame or IEEE 802.11 packet. The acknowledgment message 218 may include a source address field and a destination address field, such as an access point identifier field 356 including the address of the access point 102, and a group identifier field 358 including the address of the groupcast or multicast group of sensor nodes 106, 108, 110 to which the access point 102 sent the probe 210. The acknowledgment message 218 may also include a type identifier field, such as an acknowledgment identifier field 360 identifying the acknowledgment message 218 as an acknowledgment message, and perhaps further identifying the acknowledgment message 218 as an acknowledgment message from the access point 102 to the sensor nodes 106, 108. The acknowledgment message 218 may also include a bitmap field 362 identifying the sensor nodes 106, 108 from which the access point 102 received the data messages 216.1, 216.2, and which the access point 102 is acknowledging. The acknowledgment message 218 may also include other fields 364.

As discussed above, the access point 102 may pull data from multiple groups or multicast groups of sensor nodes. The access point 102 may pull the data from multiple groups or multicast groups sequentially or non-sequentially. The access point 102 may pull the data from all of the sensor nodes in one group or multicast group, even if the sensor nodes in the group or multicast group could not send all of their data in one data time period, and then pull data from the next group or multicast group.

FIG. 2B is a vertical time-sequence diagram showing messages exchanged between the access point 102 and two different groups of sensor nodes according to an example embodiment. The probe 210A, acknowledgments 212A, allocation 214A, data 216A1, acknowledgments 218A1, data 216A2, and acknowledgments 218A2 may be sent and received during a contention-free period, and/or the probe 210B, acknowledgments 212B, allocation 214B, data 216B, and acknowledgments 218B may be sent during a contention-free period. The access point 102 may, for example, exchange messages first with the group A of sensor nodes 104A, 106A, 108A, 110A, 112A shown in FIG. 1, and then with the group B of sensor nodes 104B, 106B, 108B, 110B, 112B shown in FIG. 1.

The access point 102 may send a probe 210A to group A. The probe 210A may request sensor nodes 104A, 106A, 108A, 110A, 112A in group A with data to send to acknowledge the probe 210A. The probe 210A may be similar to the probe 210 shown and described with respect to FIGS. 2A and 3A.

The sensor nodes 104A, 106A, 108A, 110A, 112A in group A with data to send may respond to receiving the probe 210A by sending acknowledgments 212A to the access point 102. The sensor nodes 104A, 106A, 108A, 110A, 112A may send their acknowledgments 212A by CDMA using unique or special coding sequences associated with the respective sensor nodes 104A, 106A, 108A, 110A, 112A, similar to the acknowledgment messages 212.1, 212.2, 212 discussed above with respect to FIGS. 2A and 3B.

The access point 102 may determine which sensor nodes 104A, 106A, 108A, 110A, 112A in the group A have data to send by decoding the acknowledgments 212A using each of the coding sequences associated with nodes in group A, as discussed above. The access point 102 may also determine an allocation of spectral or communication resources for the acknowledging sensor nodes. In the example shown in FIG. 2B, the access point 102 may determine that the spectral or communication resources in one data transmission period are insufficient for all of the acknowledging sensor nodes to send their data within one transmission period. The access point 102 may send an allocation 214A allocating spectral or communication resources to the acknowledging sensor nodes. The allocation 214A may have similar features to the allocation 214 shown and described with respect to FIGS. 2A and 3C. The allocation 214A may allocate a first subgroup of acknowledging sensor nodes to send data during the subsequent data transmission period, and allocate a second subgroup of acknowledging sensor nodes to send data during a later transmission period. Or, the allocation 214A may allocate the second subgroup of acknowledging sensor nodes to go to sleep, and subsequently wake up when another the access point 102 will send another allocation.

The first subgroup of acknowledging sensor nodes may send their data 216A1 during a data transmission period subsequent to the allocation 214A. The data transmission 216A1 may have similar features to the data messages 216 shown and described with respect to FIGS. 2A and 3D. After sending the data 216A1, the sensor nodes may dequeue the data from their memories, or may wait until receiving an acknowledgment from the access point 102 to dequeue the data.

After the access point 102 receives the data 216A1 from the sensor nodes, the access point 102 may acknowledge 218A1 the data. The acknowledgments 216A1 may have similar features to the acknowledgments 218 shown and described with respect to FIGS. 2A and 3E. After receiving the acknowledgments 218A1 from the access point 102, the sensor nodes may dequeue the sent data 216A1 from their memories.

After the access point 102 has acknowledged 218A1 the data 216A1, the second subgroup of acknowledging sensor nodes may send their data 216A2 to the access point 102 based on the allocation 214A, or may wakeup based on the allocation 214A and receive another allocation allocating spectral or communication resources to send their data 216A2. The data 216A2 may have similar features to the data 216.1, 216.2, 216 shown and described with respect to FIGS. 2A and 3D. The second subgroup of acknowledging nodes may dequeue the data 216A2 from their memories after sending the data, or may wait until receiving acknowledgments of the data 216A2 from the access point 102.

The access point 102 may receive the data 216A2 from the second subgroup of acknowledging nodes, and may acknowledge 218A2 the data 216A2. The acknowledgments 218A2 may have similar features to the acknowledgments 218 shown and described with respect to FIGS. 2A and 3E. The second group of acknowledging sensor nodes may respond to receiving the acknowledgments 218A2 by dequeuing the data 216A2 from their respective memories. If the two data transmission periods during which the sensing nodes sent the data 216A1, 216A2 were not sufficient for all of the acknowledging sensor nodes to send their data, then the access point 102 may have allocated more transmission time periods in the allocation 214A, and further data transmissions and corresponding acknowledgments may be sent and received until all the sensing nodes that acknowledged the probe 210A have sent their data.

After receiving all of the data 216A1, 216A2 from the sensor nodes in group A that acknowledged the probe 210A, the access point 102 may send a probe 210B to group B to query which sensor nodes 104B, 106B, 108B, 110B, 112B have data to send to the access point 102. The probe 210B may have similar features to the probe 210 shown and described with respect to FIGS. 2A and 3A. The sensor nodes in group B that have data to send to the access point 102 may send acknowledgments 212B to the access point 102. The sensor nodes may send the acknowledgments 212B to the access point using unique or special coding sequences associated with the respective sensor nodes. The acknowledgments 212B may have features similar to the acknowledgments 212.1, 212.2, 212 shown and described with respect to FIGS. 2A and 3B.

The access point 102 may decode the acknowledgments using CDMA coding sequences associated with each of the sensor nodes 104B, 106B, 108B, 110B, 112B to determine which sensor nodes sent the acknowledgments, as discussed above. The access point 102 may allocate spectral or communication resources to the acknowledging sensor nodes, as discussed above. The access point 102 may send an allocation 214B to the acknowledging sensor nodes allocating the spectral or communication resources, as discussed above. The allocation 214B may have similar features to the allocation 214 shown and described with respect to FIGS. 2A and 3C.

Using the allocated spectral or communication resources indicated by the allocation 214B, the sensor nodes may send their data 216B to the access point 102, as discussed above. The data 216B may have similar features to the data messages 216.1, 216.2, 216 shown and described with respect to FIGS. 2A and 3D. The sensor nodes may dequeue the sent data 216B, or may wait until receiving an acknowledgment from the access point 102.

Based on receiving the data 216B from the sensor nodes, the access point 102 may acknowledge 218B the data 216B. The acknowledgment 218B may have similar features to the acknowledgment message shown and described with respect to FIGS. 2A and 3E. Upon receipt of the acknowledgment 218B, the sensing nodes that sent the data 216B may dequeue the sent data 216B from their respective memories.

The access point 102 may send probe messages probing all of the groups or multicast groups for data. The access point 102 may probe groups or multicast groups sequentially, or based on instructions from the node 120 (shown in FIG. 1), according to example embodiments.

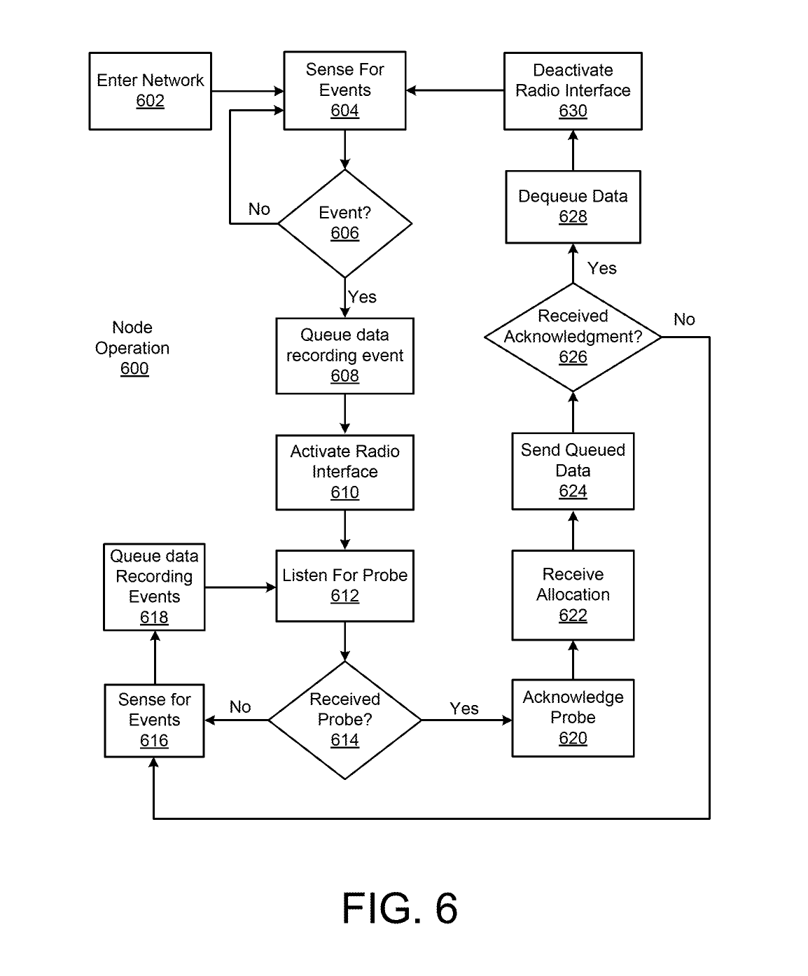

FIG. 6 is a flowchart showing sensor node operations 600 according to an example embodiment. A sensor node may enter a wireless network 100 (602). After entering the wireless network 100 (602), the sensor node may place its air or radio interface into an inactive, sleep, or low-power state. The entering the network 100 (602) may be similar to the network entry 202 described above. While in the network 100, the sensing node may sense for and/or monitor events (604). If the sensing node does not sense or determine that an event has occurred (606), then the sensing node may continue sensing for events (604).

If the sensor node does sense or determine that an event has occurred (606), then the sensor node may queue data recording the event in its memory (608). After queuing the data (608), the sensor node may activate, wake up, or power its air or radio interface (610), and listen for a probe 210 (612). As long as the sensor node does not receive a probe 210, the sensor node may continue sensing for events (616), queuing data recording events (618), and listening for a probe 210 (612), with its air or radio interface in the active, awake, or full-power state.

When the sensor node does receive the probe 210 (614), the sensor node may acknowledge 212 the probe 210 (620). After acknowledging the probe 210, the sensor node may receive an allocation 214 of spectral or communication resources (622), and send its queued data 216 to the access point via the allocated spectral or communication resources (624). If the sensor node does not receive an acknowledgment 218 of the sent data 216 (626), then the sensor node may continue sensing for events (616), queuing data recording events (618), and listening for the probe 210 (612). If the sensor node does receive an acknowledgment 218 from the access point 102 (626), then the sensor node may dequeue the data 216 that the sensor node sent to the access point 102 (628), transition its air or radio interface to inactive, sleep, or low-power mode (630), and continue sensing for events (604).

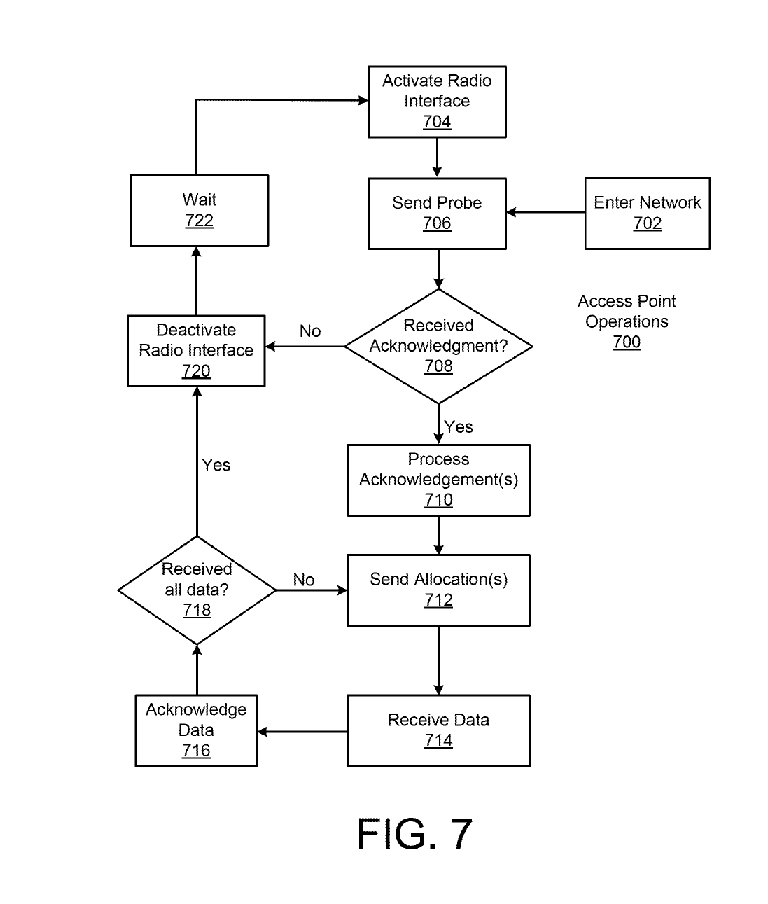

FIG. 7 is a flowchart showing access point operations 700 according to an example embodiment. The access point 102 may enter a network 100 (702), and may establish itself as the access point within the network 102. After entering the network 100 (702), the access point 102 may send a probe 210 to a group or multicast group of sensor nodes to determine if the nodes in the group have data to send (706). If the access point 102 does not receive any acknowledgments 212 to the probe 210, then the access point 102 may wait a period of time (722) and then send another probe (706), or, to save power, may transition its air or radio interface to an inactive, sleep, or low-power state (720), wait a period of time (722) before activating its air or radio interface (704) and then sending a probe 210 (706). If the access point 102 does receive an acknowledgment(s) 212 (708), then the access point 102 may process the acknowledgment(s) 212 using CDMA coding sequences associated with the sensor nodes in the group or multicast group to determine which sensor nodes sent the acknowledgment(s) 212 (712).

After processing the acknowledgment(s) 212, the access point 102 may send one or more allocations 214 to the sensor nodes that acknowledged the probe 210 allocating spectral or communication resources to the acknowledging sensor node(s) (712). After sending the allocation(s) 214 (712), the access point 102 may receive data 216 from the sensor node(s) (714), and acknowledge 218 the data 216 (716). If the access point 102 has not received all of the data 216 to be sent by the sensor nodes (718), then the access point 102 may receive more data 216 during subsequent data transmission time periods (714) and acknowledge the subsequent data 216 (716), and/or may send further allocation(s) 214 (712), receive the further data 216 via the allocated spectral or communication resources (714), and acknowledge the further data 216 (716).

If the access point 102 has received all the data 216 (718), then the access point 102 may wait (722) some amount of time (722) and send another probe 210 (706), or may transition its air or radio interface to an inactive, sleep, or low-power state (720), wait some amount of time (722), and then activate its air or radio interface (704) and send a probe 210 (704). For example, if the access point 102 is powered by a battery, or has another limited power supply which makes saving power important, the access point 102 may transition to low-power state (720), wait (722), and then activate the radio interface (704), whereas if the access point 102 has a continuous power source, such as an electrical wall outlet coupled to power grid, then the access point 102 may maintain its radio interface at full power and simply wait (722) before sending another probe 210 (704).

For downlink data transmissions, the sensor nodes may initiate the transmissions in similar manner to the access point 102 described above, by sending a probe to the access point 102 to pull data from the access point. The sensor nodes may function as access points, sending a probe under a contention scheme such as carrier sense multiple access with collision avoidance (CSMA/CA). Or, the sensor nodes may request downlink data transmissions by sending special acknowledgments to the access point in response to probes sent by the access point 102, the special acknowledgments requesting the access point 102 to send data to the requesting sensor node. The special acknowledgment may be an acknowledgment 214 with a special field identifying the acknowledgment as a special acknowledgment, or may be an additional acknowledgment sent by the sensor node to the access point 102. If the sensor node sends the special acknowledgment, then if the requested data is small enough, the access point 102 may add, append, and/or include the data in the allocation or pull message 214. If the requested data is too large to fit in the allocation or pull message 214, the access point 102 may schedule a time to send the data to the requesting sensor node, and may send the downlink data transmissions in parallel using OFDMA.

In another example, the access point 102 may indicate that the access point 102 has data to send by including a code assignment (which may be either explicit or implicit) in the probe. The node(s) may acknowledge the indication that the access point 102 has data to send, and/or request the access point 102 to send the data, by sending an acknowledgment to the access point 102 using the code included in the probe. The inclusion of the code assignment in the probe, and acknowledgment using the include code, may reduce the search space to the nodes with indicated data to receive.

In an example embodiment, the probe message 210 sent by the access point 102 to the sensor nodes may indicate whether the access point 102 has data buffered or queued for each (or any) sensor node, such as by including a field, such as a BUFFERED_DATA bit, indicating whether the access point 102 has data buffered for the sensor node. The sensor nodes for which the access point 102 has indicated, in the probe message 210, that the access point 102 has data to send, may indicate their request for the access point 102 to send the data in the acknowledgment 212, such as by setting an echo bit in the acknowledgment 212. The sensor nodes for which the access point 102 has indicated that the access point 102 has data to send may send acknowledgments 212 requesting the access point 102 to send downlink data even if the sensor nodes themselves do not have data to transmit to the access point 102. The acknowledgments 212 requesting the access point 102 to send the downlink data may indicate that the sensor node's radio interface is active, and the sensor node is ready to receive the downlink data. The access point 102 may include the data in the allocation or pull message 214. The access point 102 may send the downlink data transmissions in parallel using OFDM or OFDMA. The sensor node may acknowledge the downlink transmission data by including the acknowledgment in the data message 216.

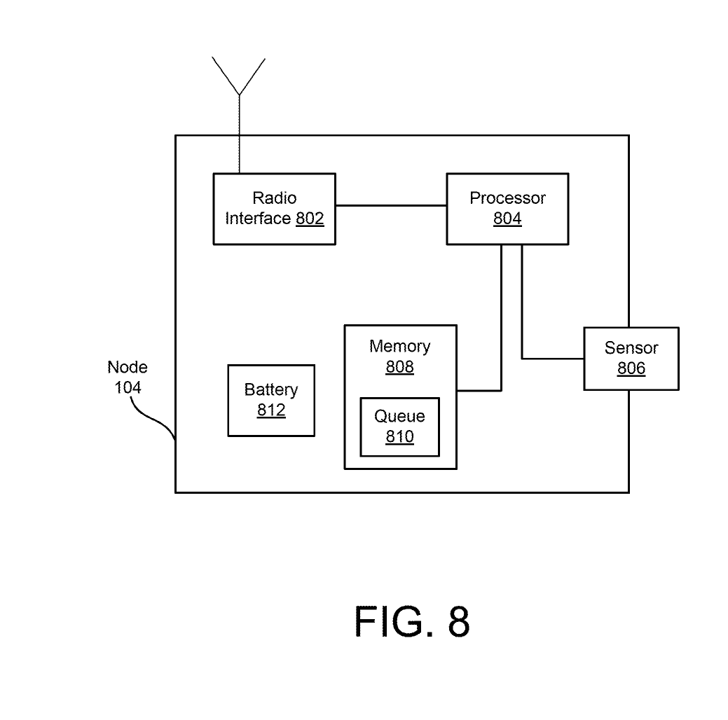

FIG. 8 is a block diagram showing a sensor node 104 according to an example embodiment. The sensor node 104 may include, for example, at least one of an air or radio interface 802, which may include an RF (radio frequency) or wireless transceiver 802, including a transmitter to transmit signals and a receiver to receive signals, a processor 804 to execute instructions or software and control transmission and receptions of signals, a sensor 806 (such as a transducer) to monitor events occurring outside the sensor node 806, a memory 808 to store data and/or instructions and to store events in a queue 810, and a battery 812 to provide power to components of the sensor node 104.

The processor 804 may also make decisions or determinations, generate frames or messages for transmission, decode received frames, packets, or messages for further processing, and other tasks or functions described herein. Processor 804, which may be a baseband processor, for example, may generate messages, packets, frames or other signals (such as those described above) for transmission via radio interface 802. Processor 804 may control transmission of signals or messages over a wireless network, and may receive signals or messages via a wireless network (e.g., after being down-converted by radio interface 802, for example). Processor 804 may be programmable and capable of executing software or other instructions stored in memory or on other computer media to perform the various tasks and functions described above, such as one or more of the tasks or methods described above. Processor 804 may be (or may include), for example, hardware, programmable logic, a programmable processor that executes software or firmware, and/or any combination of these. Using other terminology, processor 804 and radio interface 802 together may be considered as a wireless transmitter/receiver system, for example.

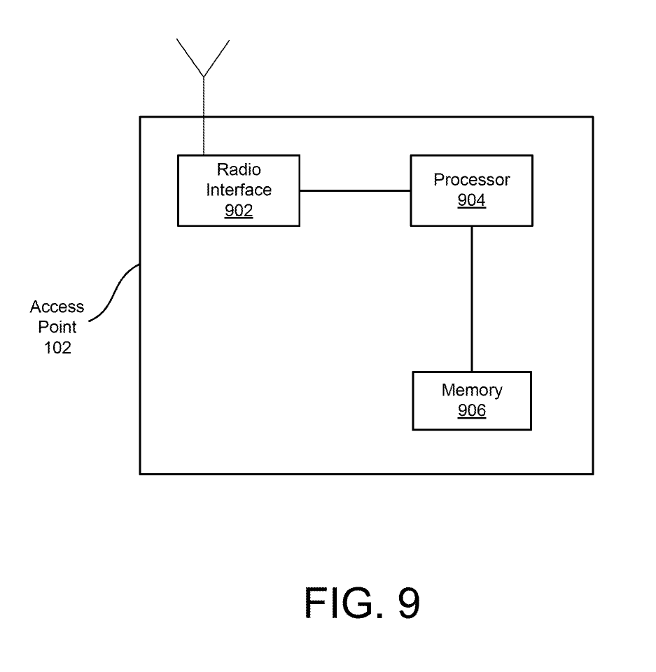

FIG. 9 is a block diagram showing an access point 102 according to an example embodiment. The access point 102 may include, for example, at least one of an air or radio interface 902, which may include an RF (radio frequency) or wireless transceiver, including a transmitter to transmit signals and a receiver to receive signals, a processor 904 to execute instructions or software and control transmission and receptions of signals, and a memory 906 to store data and/or instructions.

Processor 904 may also make decisions or determinations, generate frames or messages for transmission, decode received frames, packets, or messages for further processing, and other tasks or functions described herein. Processor 904, which may be a baseband processor, for example, may generate messages, packets, frames or other signals (such as those described above) for transmission via radio interface 902. Processor 904 may control transmission of signals or messages over a wireless network, and may receive signals or messages via a wireless network (e.g., after being down-converted by radio interface 902, for example). Processor 904 may be programmable and capable of executing software or other instructions stored in memory or on other computer media to perform the various tasks and functions described above, such as one or more of the tasks or methods described above. Processor 904 may be (or may include), for example, hardware, programmable logic, a programmable processor that executes software or firmware, and/or any combination of these. Using other terminology, processor 904 and transceiver 902 together may be considered as a wireless transmitter/receiver system, for example.

In addition, a storage medium such as the memory 906 may be provided that includes stored instructions, which when executed by a controller or processor may result in the processor 904, or other controller or processor, performing one or more of the functions or tasks described above.

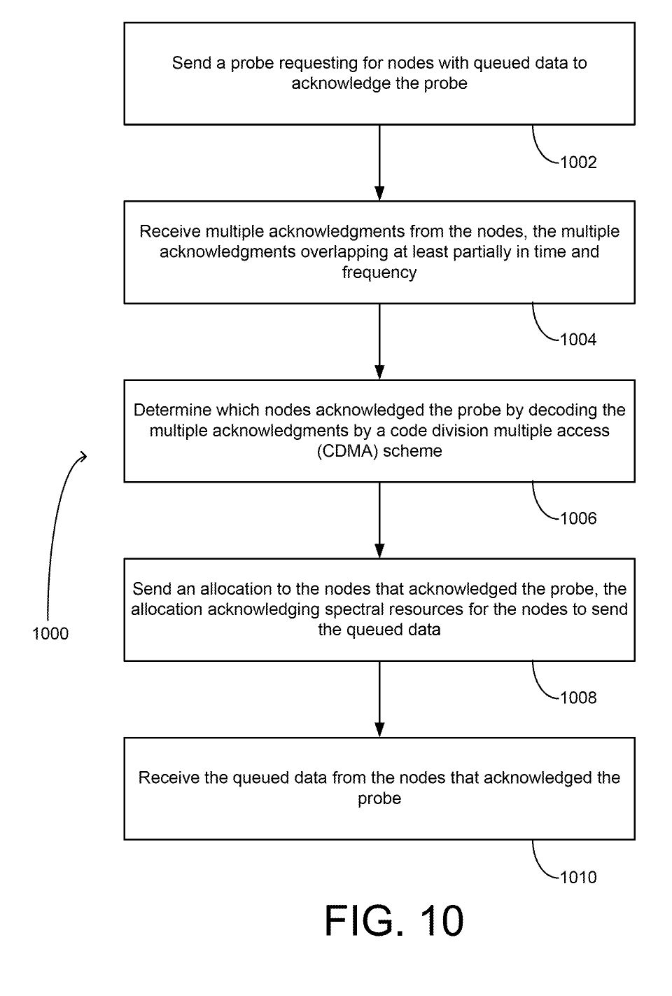

FIG. 10 is a flowchart showing a method 1000 according to an example embodiment. According to an example embodiment, the method 1000 may include sending, by an apparatus (such as an access point 102), a probe requesting for nodes with queued data to acknowledge the probe (1002). The method 1000 may also include receiving, by the apparatus, multiple acknowledgments from the nodes, the multiple acknowledgments overlapping at least partially in time and frequency (1004). The method 1000 may also include determining, by the apparatus, which nodes acknowledged the probe by decoding the multiple acknowledgments according to a code division multiple access (CDMA) scheme (1006). The method 1000 may also include sending, by the apparatus, an allocation to the nodes that acknowledged the probe, the allocation allocating spectral resources for the nodes to send the queued data (1008). The method 1000 may also include receiving, by the apparatus, the queued data from the nodes that acknowledged the probe (1010).

According to an example embodiment, the apparatus may include an IEEE 802.11 access point. The apparatus and nodes may be included in a wireless local area network (WLAN).

According to an example embodiment, the probe may include at least one of a broadcast address and a multicast address identifying a plurality of nodes in a multicast group.

According to an example embodiment, the probe may include a plurality of medium access control (MAC) addresses.

According to an example embodiment, the multiple acknowledgements may indicate a length of data to be transmitted by the respective nodes, and the allocated spectral resources may be based at least in part on the indicated length of data.

According to an example embodiment, the determining may include determining which nodes acknowledged the probe by decoding the multiple acknowledgments according to the CDMA scheme using each of a plurality of unique codewords associated with the nodes to which the probe was sent.

According to an example embodiment, the determining may include determining which nodes acknowledged the probe by decoding the multiple acknowledgments according to the CDMA scheme using each of a plurality of unique codewords which were previously assigned to the nodes via a wireless interface.

According to an example embodiment, the sending the allocation may include sending the allocation to the nodes that acknowledged the probe, the allocation allocating subcarriers and timeslots for the nodes to send the queued data.

According to an example embodiment, sending the allocation may include sending the allocation to the nodes that acknowledged the probe. The allocation may allocate overlapping subcarriers and timeslots for the sensor nodes to send the queued data.

According to an example embodiment, the sending the allocation may include sending the allocation to the nodes that acknowledged the probe by OFDM or OFDMA.

According to an example embodiment, the receiving the queued data may include receiving the queued data from the nodes that acknowledged the probe by at least one of orthogonal frequency division multiplexing (OFDM) and orthogonal frequency division multiple access (OFDMA).

According to an example embodiment, the multiple acknowledgments may each include required qualities of service (QoSs), and the method 1000 may further include determining the allocated spectral resources based at least in part in the required QoSs.

According to an example embodiment, the method 1000 may further include determining distances of the nodes based on times of receipt of the acknowledgments, and determining time slots for the nodes based at least in part on the determined distances. The allocated spectral resources may include the determined time slots.

According to an example embodiment, the method 1000 may further include determining distances of each of the nodes based on times of receipt of the acknowledgments, and determining time slots for each of the nodes based at least in part on their respective determined distances. The allocated spectral resources may include the respective determined time slots.

According to an example embodiment, the nodes include sensor nodes configured to collect data based on events occurring outside the sensor nodes.

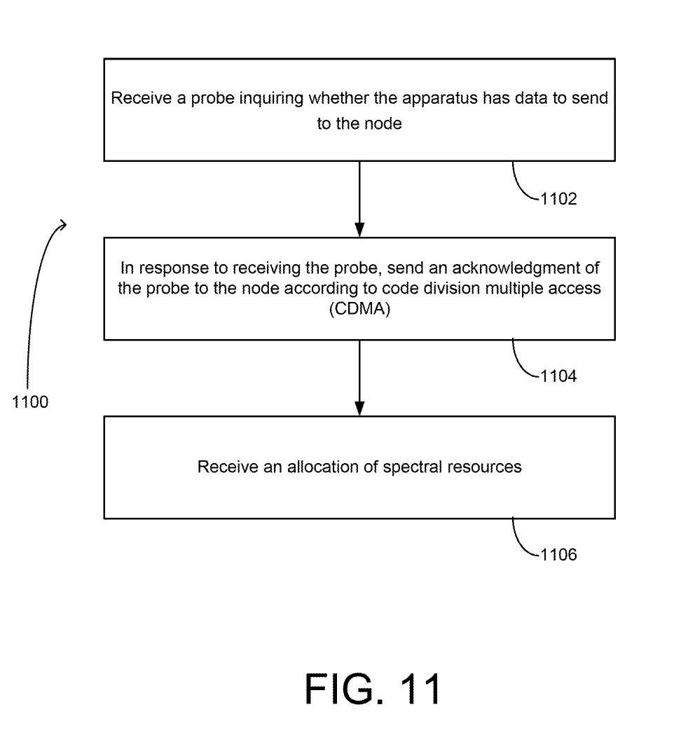

FIG. 11 is a flowchart showing a method 1100 according to another example embodiment. According to an example embodiment, the method 1100 may include receiving, by a first node from a second node, a probe inquiring whether the first node has data to send to the second node (1102). The method 1100 may also include, in response to receiving the multicast probe, sending, by the first node, an acknowledgment of the probe to the second node according to code division multiple access (CDMA) (1104). The method 1100 may also include receiving, by the first node from the second node, an allocation of spectral resources (1106).

According to an example embodiment, the probe may include a multicast address of a multicast group, the multicast group including the first node.

According to an example embodiment, the method 1100 may further include determining, by the first node, that the first node has data to send to the second node, and transitioning the wireless interface from an inactive state to an active state based on the determination that the first node has data to send to the second node.

According to an example embodiment, the method 1100 may further include monitoring an environment outside the first node. The determining may include determining that the first node has data to send based on the monitoring.

According to an example embodiment, the determining may be performed when a wireless of the first node is in the inactive state, and the receiving the probe, sending the acknowledgment, and receiving the allocation may be performed when the wireless interface is in the active state.

According to an example embodiment, the acknowledgment may indicate a length of data for the first node to transmit to the second node.

According to an example embodiment, the method 1100 may further include determining a required quality of service (QoS) based at least on part on processing the received probe. The acknowledgment may indicate the required QoS.

According to an example embodiment, the method 1100 may further include sending queued data to the second node via the allocated spectral resources.

According to an example embodiment, the sending the data may be performed when a wireless interface of the first node is in an active state.

According to an example embodiment, the method 1100 may further include transitioning the wireless interface back to the inactive state after sending the data.

According to an example embodiment, the method 1100 may further include receiving an acknowledgment of the queued data from the second node, and dequeuing the queued data based on receiving the acknowledgment of the queued data.

According to an example embodiment, the method 1100 may further include transitioning the wireless interface back to the inactive state after receiving the acknowledgment of the queued data.

According to an example embodiment, the method 1100 may further include receiving power from a battery during the receiving the probe, sending the acknowledgment, and receiving the allocation.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1-32. (canceled)

33. A method comprising:
sending, by an apparatus, a probe requesting for nodes with queued data to acknowledge the probe;
receiving, by the apparatus, multiple acknowledgments from the nodes, the multiple acknowledgments overlapping at least partially in time and frequency;
determining, by the apparatus, which sensor nodes acknowledged the probe by decoding the multiple acknowledgments according to a code division multiple access scheme;
sending, by the apparatus, an allocation to the nodes that acknowledged the probe, the allocation allocating spectral resources for the nodes to send the queued data; and
receiving, by the apparatus, the queued data from the nodes that acknowledged the probe.

34. The method of claim 33, wherein the probe comprises at least one of a broadcast address and a multicast address identifying a plurality of nodes in a multicast group.

35. The method of claim 33, wherein the probe comprises a plurality of medium access control addresses.

36. The method of claim 33, wherein:
the multiple acknowledgements indicate a length of data to be transmitted by the respective nodes, and
the allocated spectral resources are based at least in part on the indicated length of data.

37. The method of claim 33, wherein the determining includes determining which nodes acknowledged the probe by decoding the multiple acknowledgments according to the code division multiple access scheme using each of a plurality of unique codewords associated with the nodes to which the probe was sent.

38. The method of claim 33, wherein the sending the allocation includes sending the allocation to the nodes that acknowledged the probe, the allocation allocating subcarriers and timeslots for the nodes to send the queued data.

39. The method of claim 33, wherein the sending the allocation includes sending the allocation to the nodes that acknowledged the probe, the allocation allocating overlapping subcarriers and timeslots for the sensor nodes to send the queued data.

40. The method of claim 33, wherein the receiving the queued data includes receiving the queued data from the nodes that acknowledged the probe by at least one of orthogonal frequency division multiplexing and orthogonal frequency division multiple access.

41. The method of claim 33, further comprising:
determining distances of the nodes based on times of receipt of the acknowledgments; and
determining time slots for the nodes based at least in part on the determined distances,
wherein the allocated spectral resources include the determined time slots.

42. A method comprising:
receiving, by a first node from a second node, a probe inquiring whether the first node has data to send to the second node;
in response to receiving the probe, sending, by the first node, an acknowledgment of the probe to the second node according to code division multiple access); and
receiving, by the first node from the second node, an allocation of spectral resources.

43. The method of claim 42, wherein the probe includes a multicast address of a multicast group, the multicast group including the first node.

44. The method of claim 42, wherein the acknowledgment indicates a length of data for the first node to transmit to the second node.

45. An apparatus comprising:
at least one processor; and
at least one memory comprising computer program code executable by the at least one processor, the code being configured to cause the apparatus to at least:
send a probe requesting for nodes with queued data to acknowledge the probe;
receive multiple acknowledgments from the nodes, the multiple acknowledgments overlapping at least partially in time and frequency;
determine which nodes acknowledged the probe by decoding the multiple acknowledgments according to a code division multiple access scheme;
send an allocation to the nodes that acknowledged the probe, the allocation allocating spectral resources for the nodes to send the queued data; and
receive the queued data from the nodes that acknowledged the probe.

46. The apparatus of claim 45, wherein the probe comprises at least one of a broadcast address and a multicast address identifying a plurality of nodes in a multicast group.

47. The apparatus of claim 45, wherein:
the multiple acknowledgements indicate a length of data to be transmitted by the respective nodes, and
the allocated spectral resources are based at least in part on the indicated length of data.

48. The apparatus of claim 45, wherein the determining includes determining which nodes acknowledged the probe by decoding the multiple acknowledgments according to the code division multiple access scheme using each of a plurality of unique codewords associated with the nodes to which the probe was sent.

49. The apparatus of claim 45, wherein the sending the allocation includes sending the allocation to the nodes that acknowledged the probe, the allocation allocating subcarriers and timeslots for the nodes to send the queued data.

50. An apparatus comprising:
at least one processor; and
at least one memory comprising computer program code executable by the at least one processor, the code being configured to cause the apparatus to at least:
receive a probe inquiring whether the apparatus has data to send to the node;
in response to receiving the probe, send an acknowledgment of the probe to the node according to code division multiple access; and
receive an allocation of spectral resources.

51. The apparatus of claim 50, wherein the probe includes a multicast address of a multicast group, the multicast group including the first node.

52. The apparatus of claim 50, wherein the acknowledgment indicates a length of data for the first node to transmit to the second node.
